(19) United States
(12) Patent Application Publication
(10) Pub. No.: US 2021/0087932 A1
(43) Pub. Date: Mar. 25, 2021

(54) SELF-UNDERCUT EXPANSION ANCHOR SYSTEM WITH IMPROVED CUTTERS

(71) Applicant: Robert Cousineau, Ottawa (CA)

(72) Inventor: Robert Cousineau, Ottawa (CA)

(21) Appl. No.: 16/955,322

(22) PCT Filed: May 17, 2019
(86) PCT No.: PCT/CA2019/050685

§ 371 Date: Jun. 18, 2020

(30) Foreign Application Priority Data
May 18, 2018 (CA) 3005347
Oct. 5, 2018 (CA) 3019992

(51) Int. Cl. E21D 21/00; F16B 13/00; F16B 13/06

(52) U.S. Cl. CPC E21D 21/0053; F16B 13/066; F16B 13/004

(57) ABSTRACT

The present disclosure provides a system to optimally set an anchor and a bullet within a bore hole. The anchor is comprised of at least two cutters connected to and positioned below spreading lamellae of the anchor. The cutters are comprised of a wide edge and a narrow edge, the wide edge having a width that is wider than the circumference of the spreading lamellae to facilitate the setting of the anchor. A space is also initially provided between each of the cutters and the bullet to reduce friction of anchor on the bullet during expansion. During setting, the spreading lamellae of the anchor spread radially over the bullet to set the undercut anchor within the pre-drilled bore hole. In another embodiment, the anchor is comprised of at least two angular cutters having a taper of several degrees to facilitate cutting through the cementitious material of the bore hole.

### FIELD

The invention relates to the field of anchors, and more specifically to a self-undercut expansion anchor system having improved bore cutters for use in cementitious materials.

### BACKGROUND

Self-undercut anchor systems are generally comprised of an anchor to set over a bullet in a bore hole. During typical installation, the spreading lamellae of the anchor will spread out radially over the bullet and into the cementitious material of the bore hole. Inventions have been disclosed to facilitate the spreading of such lamellae, including utilizing a carbide bit onto the spreading lamellae to dig into the bore hole to set the anchor.

Unfortunately, such carbide bits are not always optimal to set the anchor, and there is a need for a device utilizing cutters positioned either on or below the anchor to better expand the anchor radially into the bore hole and set the anchor.

### SUMMARY

In an embodiment, the present disclosure provides a self-undercut expansion anchor system for use in a pre-drilled bore hole, comprising an anchor further comprised of at least two angular cutters positioned at a lower end of the anchor and separated by a slit, to cut through a material of the pre-drilled bore hole; and, a bullet connected to the anchor to provide a surface on which the at least two angular cutters can expand and radially cut into the pre-drilled bore hole, wherein the lower end of the anchor expands radially over the bullet to set the system in the pre-drilled bore hole.

In another embodiment, the present disclosure provides a self-undercut expansion anchor system for use in a pre-drilled bore hole, comprising an anchor further comprised of at least two cutters, the at least two cutters connected to and positioned below at least two corresponding spreading lamellae of the anchor, to cut through a material of the pre-drilled bore hole; and, a bullet connected to the anchor to provide a surface on which the at least two cutters and at least two spreading lamellae can expand and radially cut into the pre-drilled bore hole, wherein the lower end of the anchor expands radially over the bullet to set the system in the pre-drilled bore hole, and wherein a wide edge of the at least two cutters is flush with slits of the anchor.

### BRIEF DESCRIPTION OF THE DRAWINGS

The following figures serve to illustrate various embodiments of features of the disclosure. These figures are illustrative and are not intended to be limiting.

FIG. 1 is a perspective exploded view of an improved expansion anchor and a bullet, according to an embodiment of the present disclosure;

FIG. 2 is a perspective view of the bullet secured within the improved anchor, according to an embodiment of the present disclosure;

FIG. 3 is a bottom view of the anchor, according to an embodiment of the present disclosure;

FIG. 4 is an enlarged front cutaway view a lower portion of the anchor, according to an embodiment of the present disclosure;

FIG. 5 is a front cutaway view of a setting tool being inserted into the anchor and the bullet to be in turn inserted into a bore hole, according to an embodiment of the present disclosure;

FIG. 6 is a front cutaway view of the setting tool engaged within the anchor, the anchor and bullet being positioned into the bore hole before drilling has begun, according to an embodiment of the present invention;

FIG. 7 is a front cutaway view of the setting tool being hammered and drilled within the anchor, the anchor spreading over the bullet during the setting of the anchor, according to an embodiment of the present invention;

FIG. 8 is a front cutaway view of the anchor set in an undercut position within the pre-drilled bore hole and the setting tool being removed from the anchor after drilling has been completed, according to an embodiment of the present invention;

FIG. 9 is a perspective exploded view of a self-undercut expansion anchor system, according to another embodiment of the present disclosure;

FIG. 10 is a bottom view of an anchor taken along the lines FIG. 10 as shown in FIG. 9, according to another embodiment of the present disclosure;

FIG. 11 is side cross-sectional view of the anchor taken along the lines FIG. 11 as shown in FIG. 10, according to another embodiment of the present disclosure;

FIG. 12 is a perspective exploded view of a self-undercut anchor system and a setting tool, according to another embodiment of the present disclosure;

FIG. 13 is a side cross-sectional view of the setting tool positioned within the self-undercut expansion anchor system, according to another embodiment of the present disclosure;

FIG. 14 is a perspective view of the setting tool being hammered and rotated thus forcing the anchor to spread over a bullet of the self-undercut expansion anchor system, according to another embodiment of the present disclosure;

FIG. 15 is a side cross-sectional view of the setting tool being hammered and rotated thus forcing the anchor to spread over the bullet of the self-undercut expansion anchor system, according to another embodiment of the present disclosure;

FIG. 16 is a perspective exploded view of a self-undercut anchor system, according to another embodiment of the present disclosure;

FIG. 17 is a perspective view of the self-undercut anchor system of FIG. 16 when the anchor is spread over the bullet;

FIG. 18 is a front cross-sectional view of the self-undercut anchor system of FIG. 16 when the anchor is set in a cementitious material and a threaded component is about to be engaged to the bullet;

FIG. 19 is a front cross-sectional view of the self-undercut anchor system of FIG. 16 when the anchor is set in a cementitious material and a threaded component is engaged to the bullet;

FIG. 20 is a front view of a drop-in anchor according to another embodiment of the present disclosure;

FIG. 21 is a front cross-sectional view of the drop-in anchor of FIG. 20 according to another embodiment of the present disclosure;

FIG. 22 is a bottom view of the drop-in anchor of FIG. 20 according to another embodiment of the present disclosure;

FIG. 23 is an enlarged view of the cutters as shown in FIG. 22, according to another embodiment of the present disclosure;

FIG. 24 is an enlarged view of the cutters as shown in FIG. 20 according to another embodiment of the present disclosure;

FIG. 25 is a front view of a drop-in anchor according to another embodiment of the present disclosure;

FIG. 26 is a front cross-sectional view of the drop-in anchor of FIG. 25 according to another embodiment of the present disclosure;

FIG. 27 is a bottom view of the drop-in anchor of FIG. 25 according to another embodiment of the present disclosure;

FIG. 28 is a front view of a drop-in anchor according to another embodiment of the present disclosure;

FIG. 29 is a top view of the drop-in anchor of FIG. 28 according to another embodiment of the present disclosure;

FIG. 30 is a bottom view of an anchor having cutters according to an embodiment of the present disclosure;

FIG. 31 is a bottom view of an anchor having cutters according to another embodiment of the present disclosure; and,

FIG. 32 is a bottom view of an anchor having cutters according to yet another embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

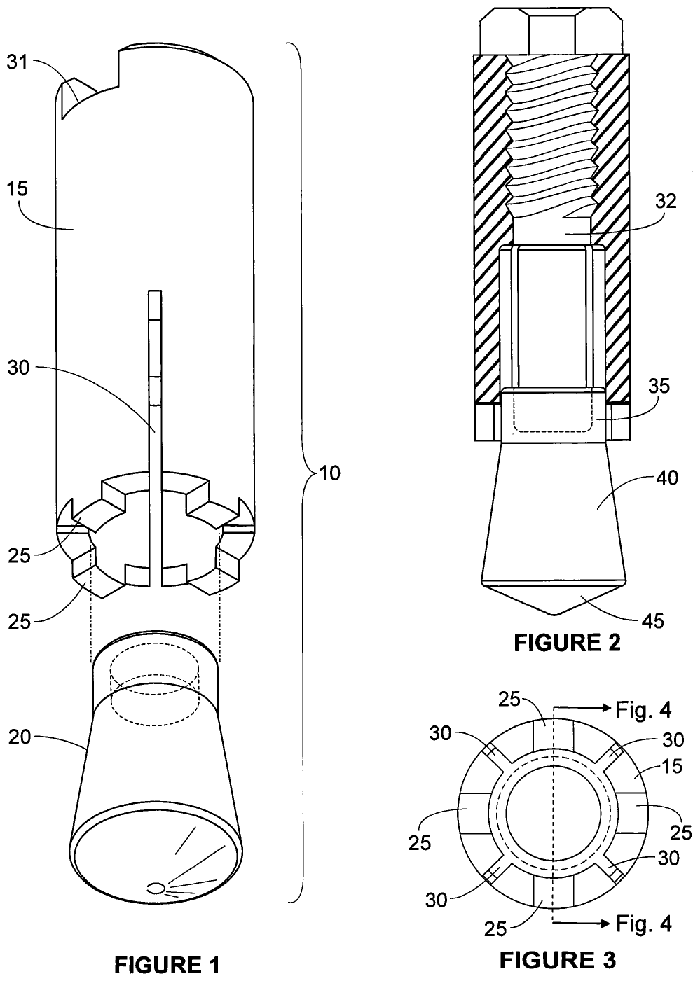

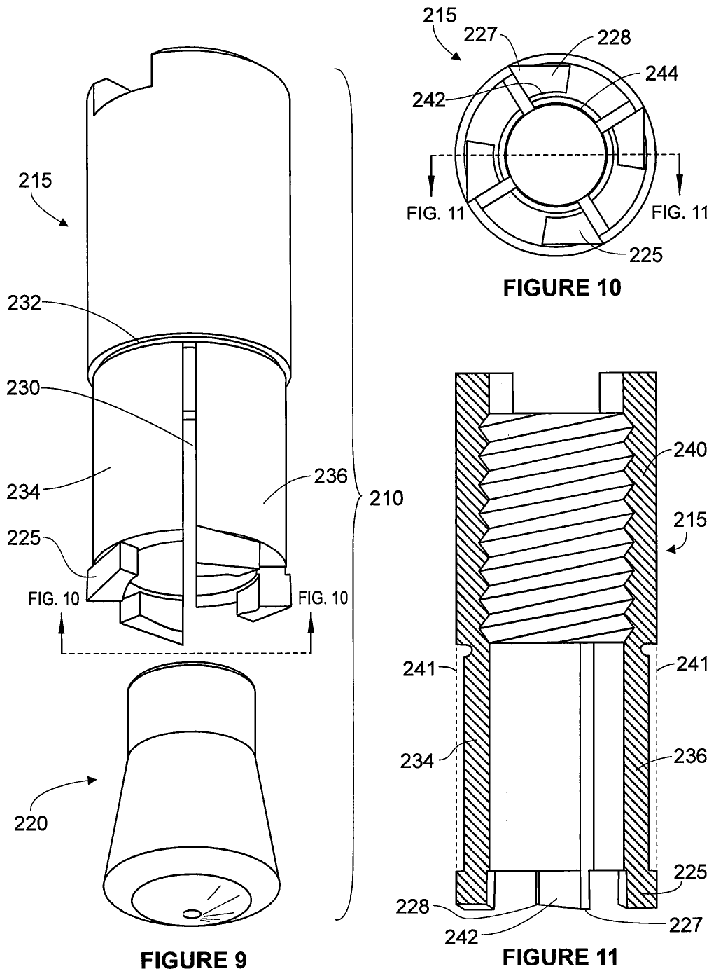

With reference to FIGS. 1, 2 and 3 and according to an embodiment of the present disclosure, a self-undercut expansion anchor system 10 for use in a pre-drilled bore hole is shown, preferably comprising an improved anchor 15 and a bullet 20. The anchor 15 is further comprised of at least two angular cutters 25 positioned at a lower end of the anchor 15. Although this preferred embodiment describes four cutters 25, a worker skilled in the art would understand that any number of cutters are possible, although four cutters have been shown to be optimal. A worker skilled in the art would appreciate that the cutters 25 could be in the form of brazed carbide on the anchor 15, without departing from the scope of the disclosure. The anchor 15 is also comprised of at least two, and preferably four, slits 30 positioned at the lower end of the anchor 15. As shown, the four slits 30 are positioned equidistantly from one another on the anchor 15. The slits 30 run up along the length of the anchor 15, from the lower end of the anchor 15 until approximately halfway up the anchor 15. As shown, the slits 30 are preferably positioned in between adjacent cutters 25. A worker skilled in the art would appreciate that the slits 30 allow for the lower end of the anchor 15 to spread radially over the bullet 20 during setting of the anchor 15. In another embodiment of the anchor 15, an annular recess (not shown) may be positioned in the area where the slit terminates halfway up the anchor 15. Such an annular recess (not shown) may facilitate the spreading of the cutters 25 and the lower end of the anchor 15 positioned below the such an annular recess (not shown). A worker skilled in the art would appreciate that in an alternate embodiment, the cutters 25 could be positioned on the spreading lamellae (an example being shown as 234, 236 in FIG. 9) of the anchor 25. The anchor 15 is also comprised of at least one locking aperture 31 positioned at an upper end of the anchor 15. Such a locking aperture 31 facilitates mating with a setting tool (not shown). As specifically shown in FIG. 2, the anchor 15 has a partially threaded hollow inner diameter 32 to receive the setting tool (not shown), a fixture (not shown), or the bullet 20 as described below. Indeed, a bullet 20 is shown connected to the anchor 15, the bullet 20 preferably bell-shaped and further comprising a neck 35 and a trapezoid-shaped body 40 terminating in a cone-shaped tip 45. The neck 35 of the bullet 20 is connected to and positioned within the lower end of the anchor 15, as specifically shown in FIG. 2. As will be described, during the setting of the anchor 15, the lower end of the anchor 15 spreads radially over the body 40 of the bullet 20 to secure the anchor 15 and the bullet 20 within the bore hole.

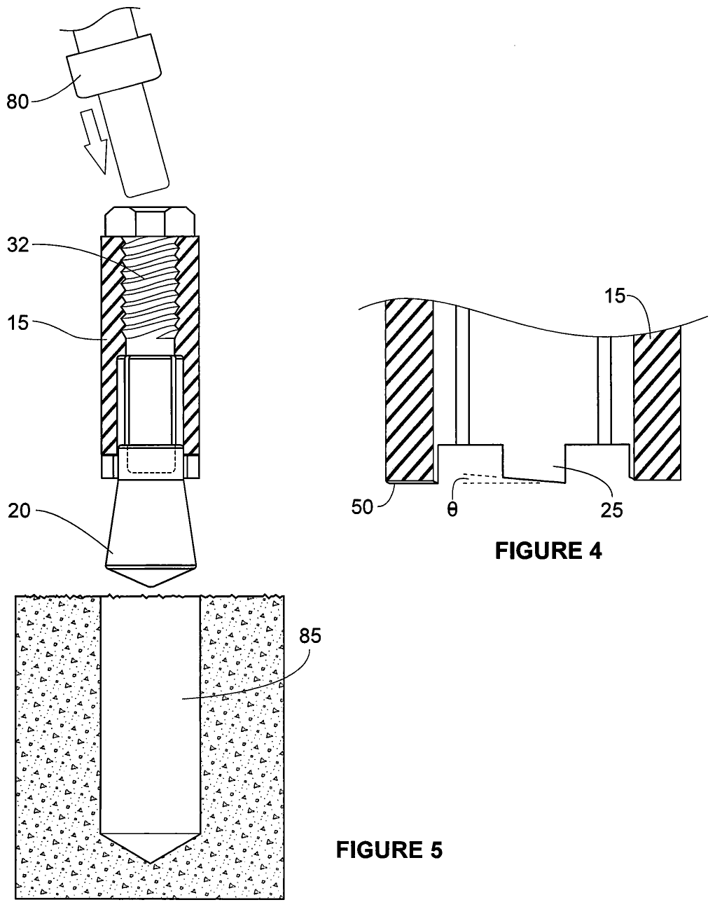

With reference to FIG. 4 and according to an embodiment of the present disclosure, one of the cutters 25 of the anchor 15 is shown in greater detail. As shown, each cutter 25 has a sloped cutting surface 50, each sloped cutting surface 50 having an optimal cutting angle θ at least 5°. The optimal cutting angle θ has been shown to perform optimally when cutting and boring through the cementitious material of the pre-drilled bore hole, to optimize the strength of the anchor 15 and optimally set the anchor 15 in an undercut position in the pre-drilled bore hole. In an alternate embodiment, the sloped cutting surface 50 could slope from each side and terminate to form a notch or triangular shape, provided that each taper is at least 5°.

With reference to FIG. 5 and according to an embodiment of the present disclosure, the bullet 20 is shown connected to the anchor 15, with a setting tool 80 about to be inserted within the hollow inner diameter 32 of the anchor 15. In turn, the anchor 15 and bullet 20 are about to be inserted within the bore hole 85.

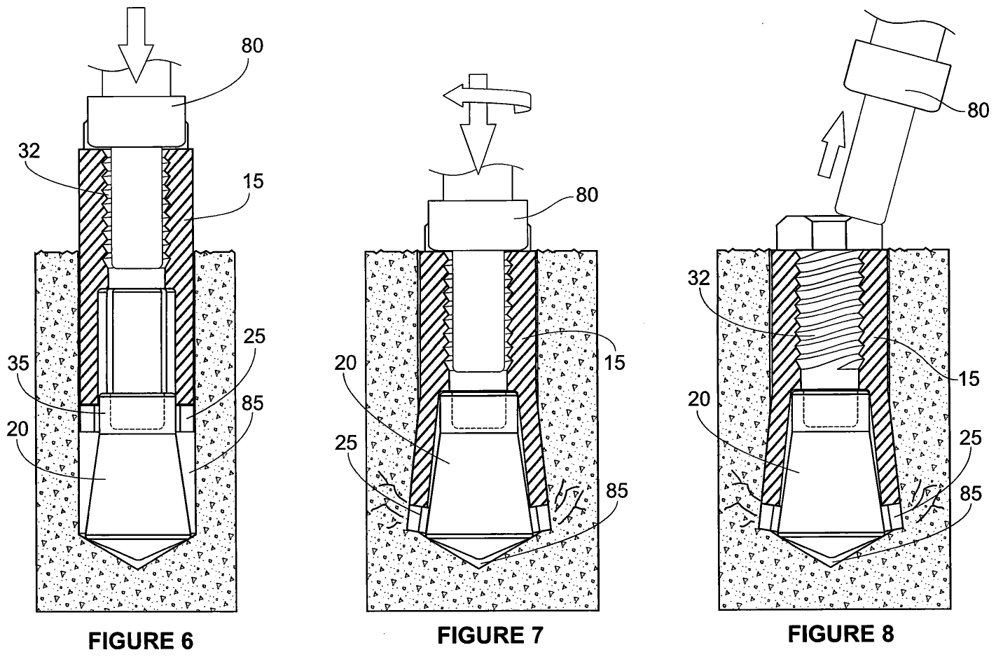

With reference to FIGS. 6, 7 and 8, the anchor 15 is shown being set over the bullet 20 and within the bore hole 85. With specific reference to FIG. 6, the anchor 15 and bullet 20 are within the bore hole 85. Meanwhile, the setting tool 80 is inserted within the hollow inner diameter 32 of the anchor 15, and the neck 35 of the bullet 20 is connected to the lower end of the anchor 15. The cutters 25 have not yet cut or bore into the cementitious material. With specific reference to FIG. 7, a hammer drill or other impact tool as known in the art acts on the setting tool 80 to hammer and rotate the setting tool 80 and in turn the anchor 15. As the anchor 15 is driven downwardly into the bore hole 85, the lower end of the anchor 15 begins to expand over the bullet 20. The slits (not shown) facilitate the expansion of the anchor 15 over the bullet 20, and the cutters 25 cut and bore through the cementitious material to enlarge in the pre-drilled bore hole 85. With specific reference to FIG. 8, the anchor 15 has been maximally expanded over the bullet 20 and is set in an undercut position. As shown in this undercut position, the diameter of the set anchor 15 is wider than the diameter of the pre-drilled bore hole 85 and thusly secured therein. The setting tool 80 is removed from the hollow inner diameter 32 of the anchor 15 and an operator can then insert a threaded component, such as a fixture, into the anchor 15.

With reference to FIGS. 9, 10 and 11 and according to another embodiment of the present disclosure, a self-undercut expansion anchor system 210 for use in a pre-drilled bore holes is shown, preferably comprising an anchor 215 and a bullet 220. The anchor 215 is further comprised of at least two jagged cutters 225, each of the cutters 225 positioned at a lower end of the anchor 215 on and below spreading lamellae 234, 236. Although this preferred embodiment illustrates four cutters 225, a worker skilled in the art would understand that any number of cutters are possible, although four cutters have been shown to be optimal. A worker skilled in the art would appreciate that the cutters 225 could be in the form of brazed carbide on the anchor 215, without departing from the scope of the disclosure. Each of the cutters 225 is further comprised of a wide edge 227 and a narrow edge 228, such edges 227, 228 will be further described below. The anchor 215 is also comprised of at least two, and preferably four, slits 230 positioned at the lower end of the anchor 215. As shown, the four slits 230 are positioned equidistantly from one another on the anchor 215 and separate the spreading lamellae 234, 236. The slits 230 run up along the length of the anchor 215, from the lower end of the anchor 215 until approximately halfway up the anchor 215. As shown, the wide edges 227 of the four cutters 225 are preferably positioned adjacent to and flush with each of the four slits 230. A worker skilled in the art would appreciate that the slits 230 allow for the lamellae 234, 236 and cutters 225 to spread radially over the bullet 220 during setting of the anchor 215. Indeed, the anchor 215 is further comprised of an annular recess 232 to facilitate the radial spreading of the lamellae 234, 236 and cutters 225 over the bullet 220.

With specific reference to FIGS. 10 and 11, the cutters 225 are shown having a wide edge 227 and a narrow edge 228. The wide edge 227 of the cutters 225 will be the first point of contact between the anchor 215 and the inner walls of the bore hole (not shown). Indeed, the wide edge 227 of the cutters 225 extends wider than the circumference of the lamellae 234, 236. The outer periphery of the wide edge 227 of the cutters 225 is the same width as the diameter of an upper portion 240 of the anchor 215, as shown by the stippled line 241 in FIG. 11. Such a shape, width and placement of the cutters 225 has been shown to provide an improved setting of the anchor 215 in a bore hole (not shown). The cutters 225 are comprised of curved inner sides 242, the curved inner sides 242 positioned in proximity to but not flush with an inner wall 244 of the anchor 215. The spacing between the curved inner sides 242 of the cutters 225 and the inner wall 244 of the anchor 215, as best shown in FIG. 10, is necessary as such a spacing ensures that the cutters 225 do not come in contact with an upper portion of the cone portion (not shown) of the bullet (not shown). This reduces and can eliminate friction between the cutters 225 and the bullet (not shown) during expansion of the anchor system (not shown).

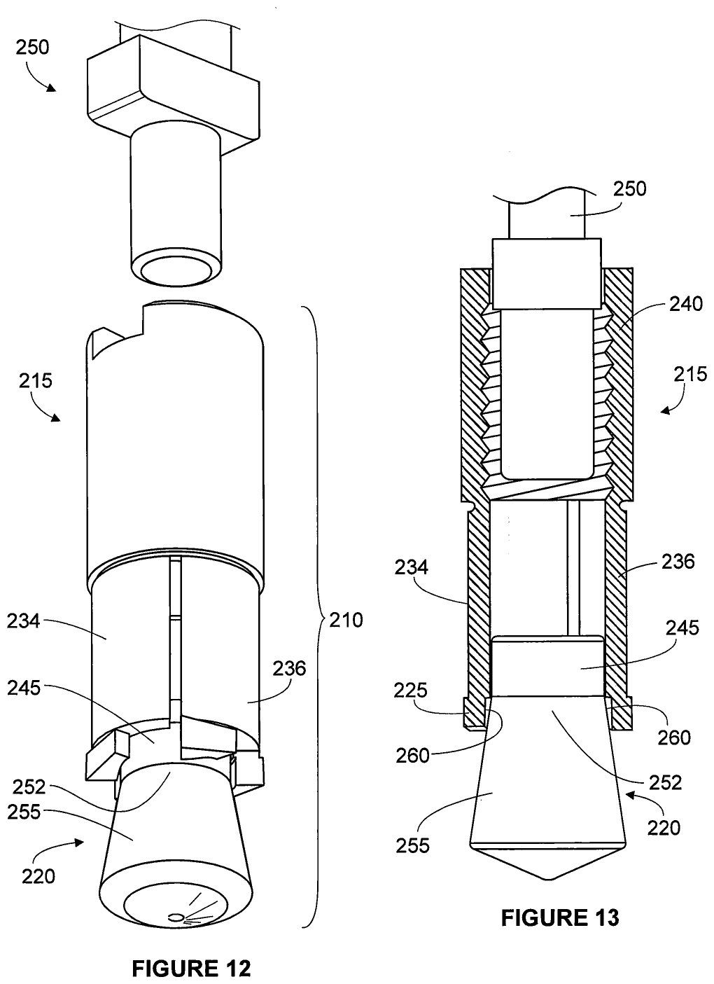

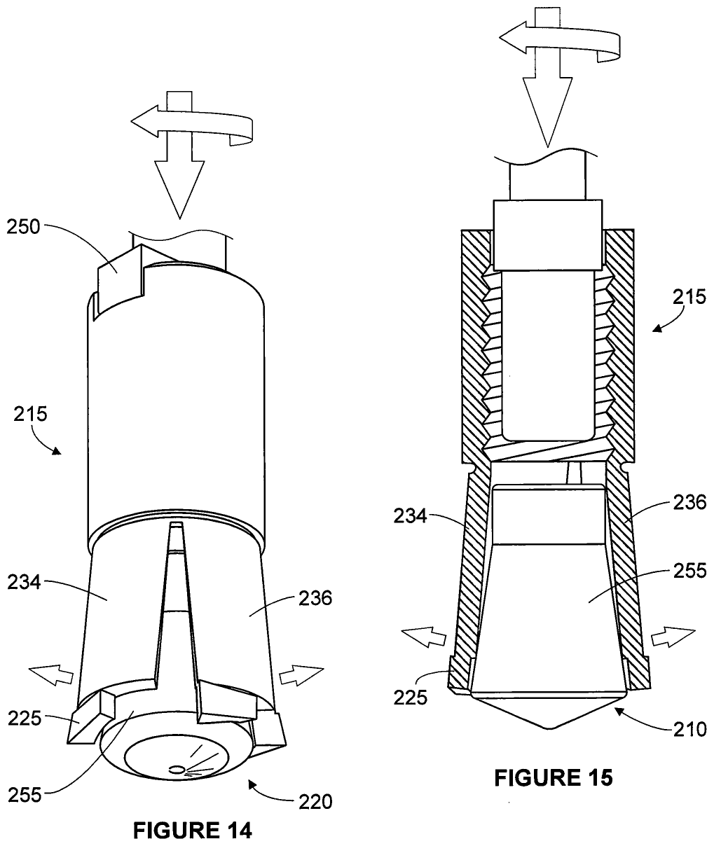

With reference to FIGS. 12, 13, 14 and 15 and according an embodiment of the present disclosure, the self-undercut expansion anchor system 210 is shown being connected to a setting tool 250 and having the setting tool 250 expand the anchor 215 over the bullet 220. With specific reference to FIG. 12, the anchor 215 is shown about to be positioned over the neck 245 and upper portion 252 of the cone portion 255 of a bullet 220. Meanwhile, the setting tool 250 is shown about to connect to the anchor 215. With specific reference to FIG. 13, the setting tool 250 is shown inserted within the upper portion 240 of the anchor 215. A lower portion of the spreading lamellae 234, 236 is showing surrounding the neck 245 of the bullet 220. Meanwhile, the cutters 225 are positioned over the upper portion 252 of the cone portion 255 of the bullet 220 without making contact with the cone portion 255, the bullet 220 being held in place by the inner walls of the anchor 215. Indeed, spaces 260 are provided between the cutters 225 and the neck 245 of the cone portion 255 of the bullet 220, to eliminate friction that would otherwise occur if the cutters 225 made contact with the cone portion 255. With specific reference to FIGS. 14 and 15, the setting tool 250 is shown being hammered and rotated, usually by a rotary hammer drill or another impact tool, to force the spreading lamellae 234, 236 of the anchor 215 over the cone portion 255 of the bullet 220. The cutters 225, connected to and positioned below the spreading lamellae 234, 236 abut against and dig into the inner wall of the bore hole (not shown) and serve to secure the anchor 215 in an undercut position within the bore hole (not shown).

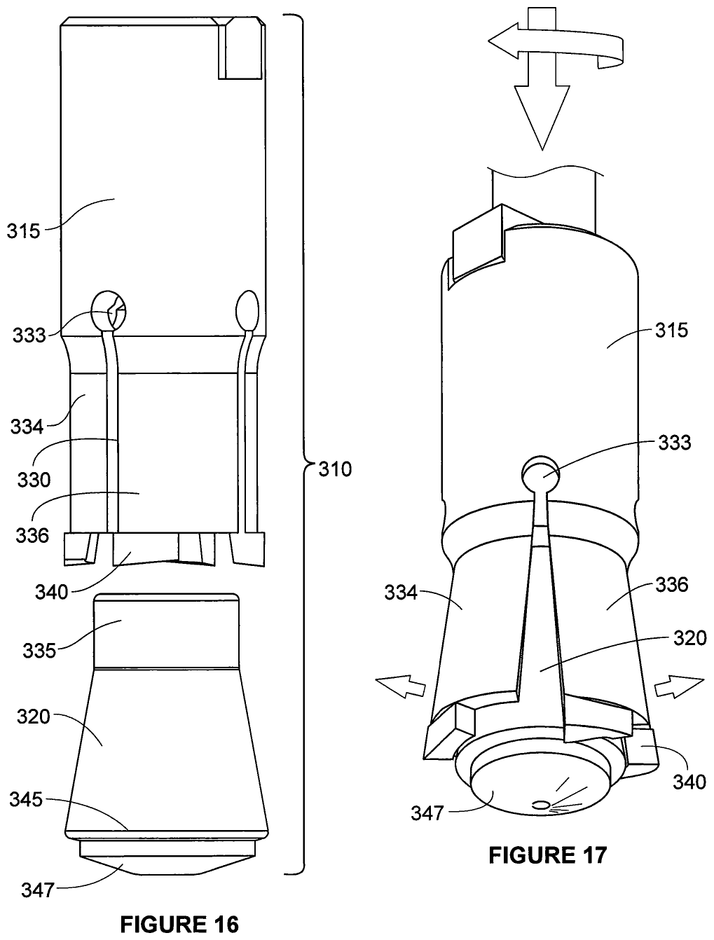

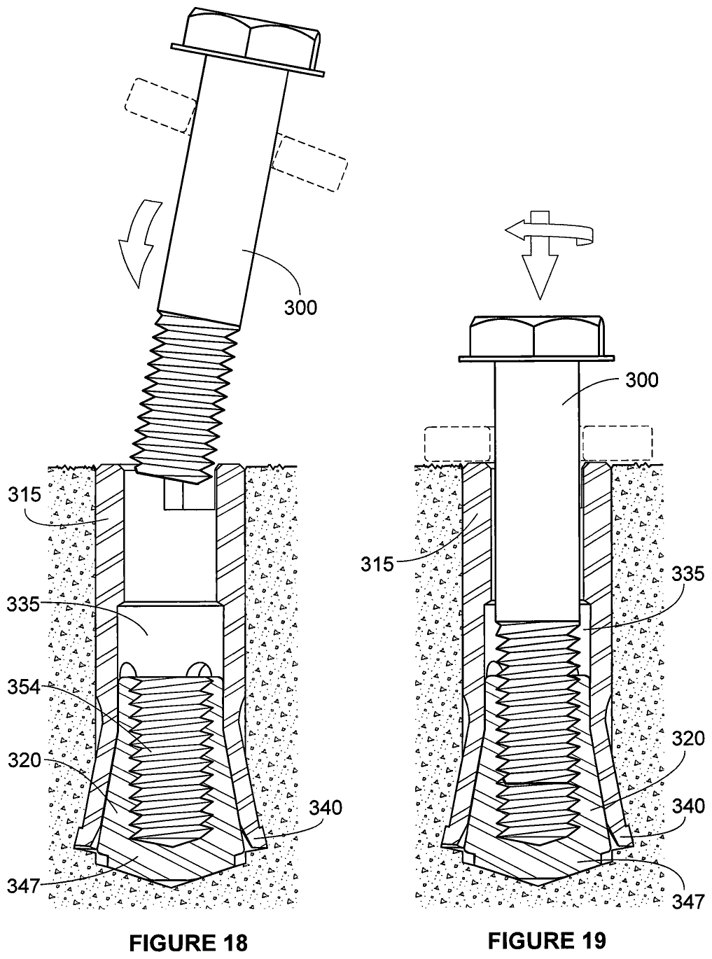

With reference to FIGS. 16, 17, 18 and 19 and according to another embodiment of the present disclosure, a self-undercut expansion anchor system 310 for use in a pre-drilled bore holes is shown, preferably comprising an anchor 315 having cutters 340 and a bullet 320. In this alternate embodiment, the anchor 315 has slits 330 terminating in corresponding openings 333, such openings 333 to facilitate the spreading of the lamellae 334, 336. Indeed, it has been shown that such openings 333 provide better anchoring and spreading of the lamellae 334, 336. The bullet 320 is shown comprised of a neck 335 terminating in a cone-shaped tip 345, the cone-shaped-tip 345 having a recessed lower portion 347, which also further assists in the setting of the anchor 315. The bullet 320 is further comprised of inner threading 354 to engaged with a threaded component such as a bolt 300 or fixture.

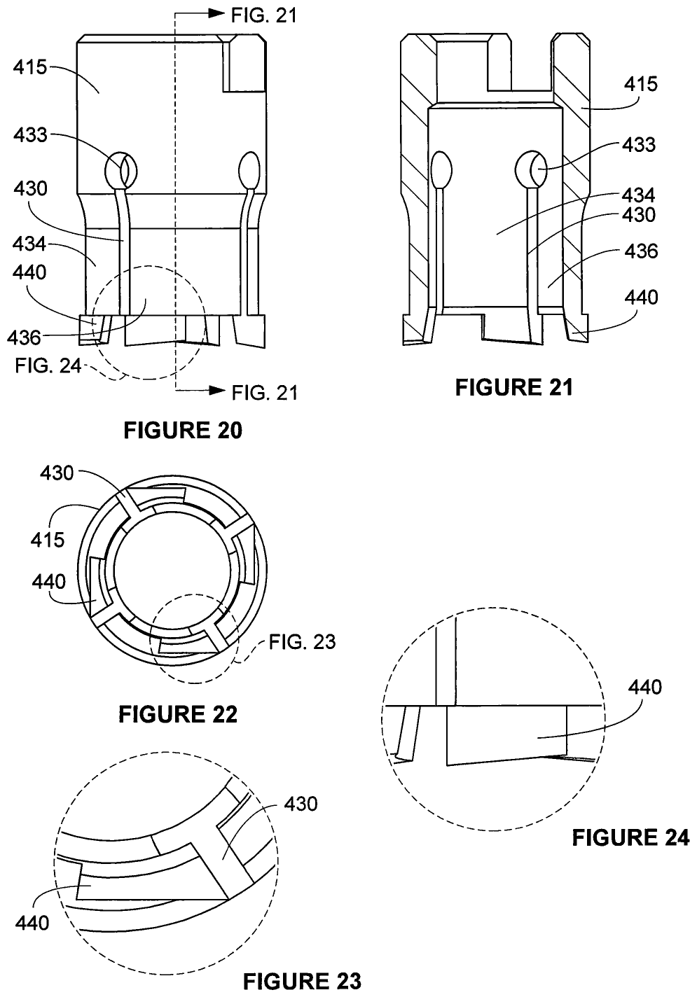

With reference to FIGS. 20, 21, 22, 23 and 24 and according to another embodiment of the present disclosure, a drop-in anchor 415 having cutters 440 is shown. The drop-in anchor 415 also has a plurality of slits 430 that form spreading lamellae 434, 436. The slits 430 terminate in corresponding openings 433 to facilitate the spreading of the lamellae 434, 436. With specific reference to FIGS. 22, 23 and 24, various views of the cutters 440 are shown showing their shape in greater detail.

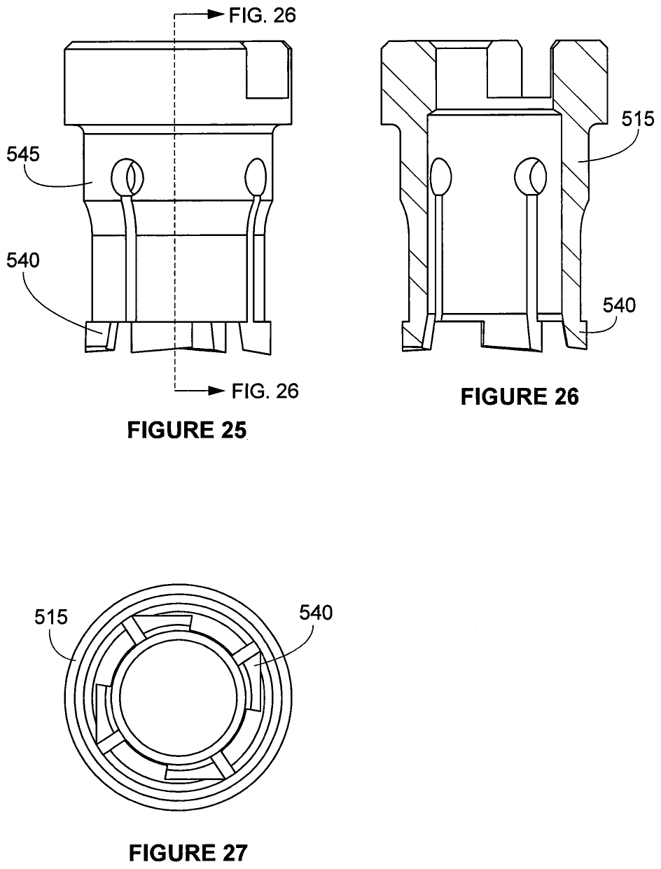

With reference to FIGS. 25, 26 and 27 and according to another embodiment of the present disclosure, a drop-in anchor 515 having cutters 540 is shown. The drop-in anchor 515 is shown having a wider upper end that has a width that is flush with an outer edge of the cutters 540. The top portion of the anchor 515 is wider than the body of the anchor 515 to facilitate mating with a setting tool.

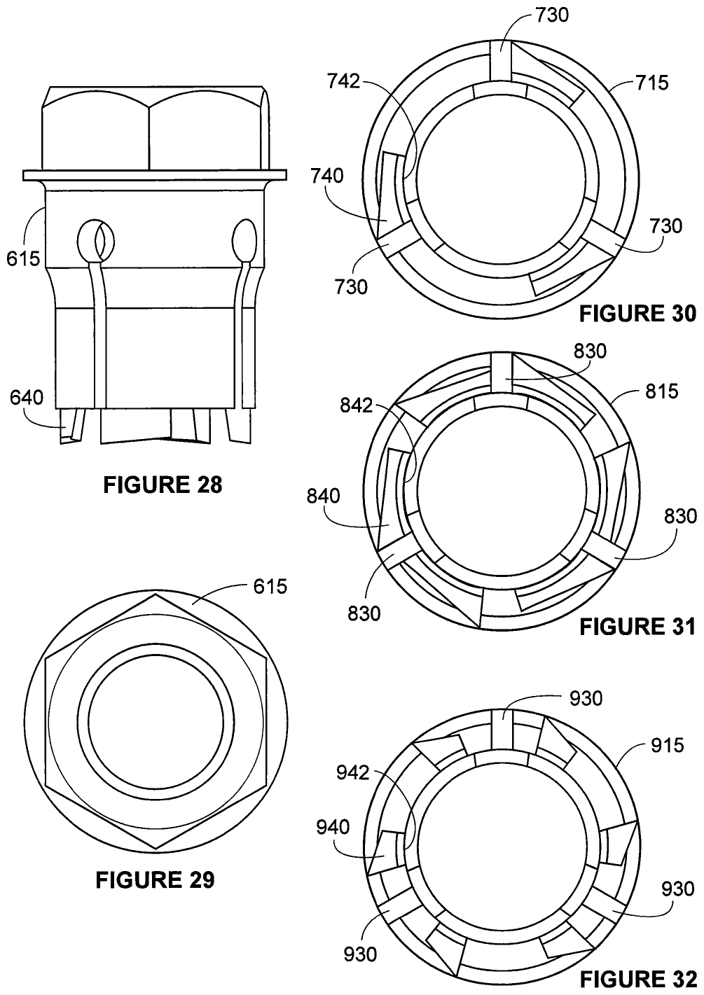

With reference to FIGS. 28 and 29 and according to another embodiment of the present disclosure, a drop-in anchor 615 having cutters 640 is shown. The drop-in anchor 615 is shown having a hex bolt-shaped upper end to facilitate mating with the appropriate tool to set the anchor 615.

With reference to FIGS. 30, 31 and 32 and according to another embodiment of the present disclosure, various width of the cutters are shown, each cutters 740, 840, 940 having a curved inner surface 742, 842, 942, respectively. The outer tip of the cutters 740, 840, 940 also aligns with the widest diameter of the anchors 715, 815, 915, such widest diameter to be at an upper end thereof. As shown, the anchors 715, 815, 915 have three slits 730, 830, 930, to have three spreading lamellae, which has been shown to be an optimal number for anchors 715, 815, 915.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A self-undercut expansion anchor system for use in a pre-drilled bore hole, comprising:
an anchor further comprised of at least two angular cutters positioned at a lower end of the anchor and separated by a slit, to cut through a material of the pre-drilled bore hole; and,
a bullet connected to the anchor to provide a surface on which the at least two angular cutters can expand and radially cut into the pre-drilled bore hole,
wherein the lower end of the anchor expands radially over the bullet to set the system in the pre-drilled bore hole.

2. The self-undercut expansion anchor system of claim 1 wherein the at least two angular cutters have a sloped cutting surface, each of the sloped cutting surfaces having an optimal cutting angle θ, whereby θ is at least 5° degrees.

3. The self-undercut expansion anchor system of claim 1 wherein the at least two angular cutters have two sloped cutting surfaces forming a notch.

4. The self-undercut expansion anchor system of claim 1 wherein the anchor is further comprised of at least two slits, the at least two slits running up along a length of the anchor, from a lower end of the anchor until approximately halfway up the anchor.

5. The self-undercut expansion anchor system of claim 1 wherein the anchor is further comprised of an annular recession to facilitate the spreading the cutters and spreading lamellae.

6. A self-undercut expansion anchor system for use in a pre-drilled bore hole, comprising:
an anchor further comprised of at least two cutters, the at least two cutters connected to at least two corresponding spreading lamellae of the anchor, to cut through a material of the pre-drilled bore hole; and,
a bullet connected to the anchor to provide a surface on which the at least two cutters and at least two spreading lamellae can expand and radially cut into the pre-drilled bore hole,
wherein the lower end of the anchor expands radially over the bullet to set the system in the pre-drilled bore hole,
and wherein a wide edge of the at least two cutters is flush with slits of the anchor.

7. The self-undercut expansion anchor system of claim 6, wherein the at least two cutters are further comprised of a wide edge and a narrow edge, the cutters positioned below the two spreading lamellae.

8. The self-undercut expansion anchor system of claim 7 wherein the anchor is further comprised of at least two slits, and wide edge of the at least two cutters is flush with the at least two slits.

9. The self-undercut expansion anchor system of claim 6 wherein spaces are provided between the at least two cutters and the bullet to eliminate friction between the at least two cutters and the bullet during expansion of the self-undercut expansion anchor system.

10. The self-undercut expansion anchor system of claim 7 wherein an outer periphery of the wide edge of the cutters is the same width as a diameter of an upper portion of the anchor.

11. The self-undercut expansion anchor system of claim 7 wherein an outer periphery of the wide edge of the cutters extends beyond the at least two spreading lamellae.

12. The self-undercut expansion anchor system of claim 6 wherein each of the at least two cutters are further comprised of a curved inner surface.

13. The self-undercut expansion anchor system of claim 8 wherein the at least two slits terminate in an opening to facilitate spreading of the at least two spreading lamellae.

14. The self-undercut expansion anchor system of claim 6 wherein the bullet has a threaded center.

15. The self-undercut expansion anchor system of claim 6 wherein the bullet is further comprised of a recessed lower portion.
